(19) United States
(12) Patent Application Publication
(10) Pub. No.: US 2021/0010897 A1
(43) Pub. Date: Jan. 14, 2021

(54) ABNORMALITY DIAGNOSIS APPARATUS, ABNORMALITY DIAGNOSIS METHOD, AND COMPUTER READABLE RECORDING MEDIUM

(71) Applicant: NEC Corporation, Minato-ku, Tokyo (JP)

(72) Inventors: Yu KIYOKAWA, Tokyo (JP); Shigeru KASAI, Tokyo (JP); Shohei KINOSHITA, Tokyo (JP)

(73) Assignee: NEC Corporation, Minato-ku, Tokyo (JP)

(21) Appl. No.: 16/981,529

(22) PCT Filed: Mar. 23, 2018
(86) PCT No.: PCT/JP2018/011829

§ 371 Date: Sep. 16, 2020

(51) Int. Cl. G01M 7/02

(52) U.S. Cl. CPC G01M 7/025

(57) ABSTRACT

An abnormality diagnosis apparatus including: a feature amount calculation unit 2 configured to perform, on mode vectors generated based on vibration of a structure 20 measured by sensors 21, normalization of amplitude components and normalization for removing an initial phase from phase components, and calculate amplitude feature amounts corresponding to the amplitude components and phase feature amounts corresponding to the phase components; and an abnormality detection unit 3 configured to specify an abnormality in the structure 20 based on the amplitude feature amounts and the phase feature amounts.

### TECHNICAL FIELD

The present invention relates to an abnormality diagnosis apparatus and an abnormality diagnosis method for performing abnormality diagnosis of a structure, and furthermore, relates to a computer readable recording medium that includes a program for realizing the abnormality diagnosis apparatus and the abnormality diagnosis method recorded thereon.

### BACKGROUND ART

In abnormality diagnosis of a structure, an abnormality in the structure is diagnosed by comparing a plurality of mode vectors (mode shapes, etc.) acquired before the occurrence of the abnormality and a plurality of mode vectors acquired after the occurrence of the abnormality. An abnormality in a structure is a deterioration of the structure, a damage in the structure, or the like.

As a related technique, Patent Document 1 discloses a failure prediction system that performs failure prediction of a device that is monitored, such as an electronic device. According to this failure prediction system, phase correction is performed so that various detection signals, which are acquired by a vibration detection unit that detects vibration of the device or a current detection unit that detects the amount of electric current supplied to the device, share the same time axis.

Patent Document 2 discloses a structure deterioration diagnosis system that diagnoses the deterioration state of a structure. According to this structure deterioration diagnosis system, feature amounts relating to inclination and feature amounts relating to natural frequencies are extracted based on acceleration information acquired from the structure on which deterioration diagnosis is performed. Furthermore, based on each type of feature amount, inter-distribution distances are calculated by comparing probability density distributions which were acquired when learning was performed and which correspond to reference data in a normal state, and probability density distributions based on measurement results acquired when deterioration diagnosis is performed, and it is determined that deterioration has occurred if a significant difference is detected.

Patent Document 3 discloses a robot system that performs diagnosis on a concrete structure. According to this robot system, the healthiness of the concrete structure is analyzed using vibration modes.

Non-Patent Document 1 discloses a verification method for quantitatively assessing changes in mode shapes caused by damage in a structure from mode shapes acquired before and after the structure is repaired. According to this verification method, damage in the structure is verified using the Coordinate Modal Assurance Criterion (COMAC) method.

Non-Patent Document 2 discloses a method applied to a structure, in which the positions and degrees of damages in the structure are detected using mode shape estimation. According to this detection method, an attempt is made to detect the number of damages, the positions of the damages, and the degrees of damages in the structure by continuously applying wavelet transform to a difference between mode shapes.

### LIST OF RELATED ART DOCUMENTS

### Patent Document

Patent Document 1: International Publication No. 2013/027744

Patent Document 2: Japanese Patent Laid-Open Publication No. 2015-064347

Patent Document 3: Japanese Patent Laid-Open Publication No. 2009-222681

### NON-PATENT DOCUMENT

Non-Patent Document 1: Takanori Kadota and four others, “Study on the changes of the modal amplitude by repair work of a pedestrian bridge with real damage”, Japan Society of Civil Engineers, Journal of structural engineering Vol. 61A, March, 2015

Non-Patent Document 2: Ryo Arakawa, Yotsugi Shibuya, “Damage Detection Using Mode Shape of Beam Structures with Multiple Damages”, The Japan Society of Mechanical Engineers, Transactions of the JSME (Series A), Original paper No. 2011-JAR-0667, January, 2012

### SUMMARY OF INVENTION

### Problems to be Solved by the Invention

However, if abnormality diagnosis is actually performed using a plurality of mode vectors, the plurality of mode vectors include statistical variation. Due to this, if the differences between the plurality of mode vectors acquired before the occurrence of an abnormality and the plurality of mode vectors acquired after the occurrence of the abnormality are within the range of statistical variation, mode vectors acquired before and after the occurrence of the abnormality cannot be distinguished from one another. Accordingly, an abnormality in a structure cannot be accurately detected.

Also, Patent Documents 1 to 3 and Non-Patent Documents 1 and 2 described above lack any disclosure regarding suppressing the influence of statistical variation included in mode vectors, and the above-described problem cannot be solved even if the techniques disclosed in Patent Documents 1 to 3 and Non-Patent Documents 1 and 2 described above are used.

One example object of the invention is to provide an abnormality diagnosis apparatus, an abnormality diagnosis method, and a computer readable recording medium for detecting an abnormality in a structure accurately.

### Means for Solving the Problems

In order to achieve the above-described object, an abnormality diagnosis apparatus according to an example aspect of the invention includes:

a feature amount calculation unit configured to perform, on mode vectors generated based on vibration of a structure measured by sensors, normalization of amplitude components and normalization for removing an initial phase from phase components, and calculate amplitude feature amounts corresponding to the amplitude components and phase feature amounts corresponding to the phase components; and

an abnormality detection unit configured to specify an abnormality in the structure based on the amplitude feature amounts and the phase feature amounts.

Also, in order to achieve the above-described object, an abnormality diagnosis method according to an example aspect of the invention includes:

(A) a step of performing, on mode vectors generated based on vibration of a structure measured by sensors, normalization of amplitude components and normalization for removing an initial phase from phase components, and calculating amplitude feature amounts corresponding to the amplitude components and phase feature amounts corresponding to the phase components; and

(B) a step of specifying an abnormality in the structure based on the amplitude feature amounts and the phase feature amounts.

Furthermore, in order to achieve the above-described object, a computer readable recording medium that includes an abnormality diagnosis program recorded thereon, according to an example aspect of the invention, includes instructions that cause the execution of:

(A) a step of performing, on mode vectors generated based on vibration of a structure measured by sensors, normalization of amplitude components and normalization for removing an initial phase from phase components, and calculating amplitude feature amounts corresponding to the amplitude components and phase feature amounts corresponding to the phase components; and

(B) a step of specifying an abnormality in the structure based on the amplitude feature amounts and the phase feature amounts.

### Advantageous Effects of the Invention

As described above, according to the invention, an abnormality in a structure can be detected accurately.

### BRIEF DESCRIPTION OF THE DRAWINGS

FIG. 1 is a diagram illustrating one example of an abnormality diagnosis apparatus.

FIG. 2 is a diagram specifically illustrating the abnormality diagnosis apparatus and a system including the abnormality diagnosis apparatus.

FIG. 3 is a diagram illustrating one example of vibration waves of individual sensors.

FIG. 4 is a diagram illustrating one example of Fourier-transformed vibration waves.

FIG. 5 is a diagram illustrating relationships between the number of times impact is applied to a structure, and the number of times amplitude feature amounts and phase feature amounts.

FIG. 6 is a diagram illustrating one example of operations of the abnormality diagnosis apparatus.

FIG. 7 is a diagram illustrating one example of a computer realizing the abnormality diagnosis apparatus.

### EXAMPLE EMBODIMENT

### Example Embodiment

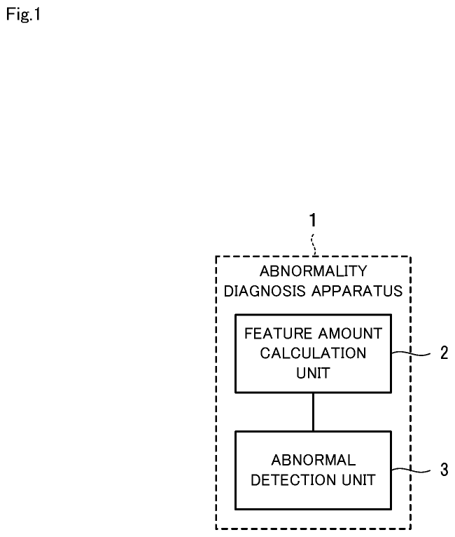

In the following, an abnormality diagnosis apparatus in an example embodiment of the invention will be described with reference to FIGS. 1 to 7.

[Apparatus Configuration]

First, a configuration of the abnormality diagnosis apparatus in the present example embodiment will be described with reference to FIG. 1. FIG. 1 is a diagram illustrating one example of the abnormality diagnosis apparatus.

As illustrated in FIG. 1, an abnormality diagnosis apparatus 1 is an apparatus that accurately detects an abnormality in a structure, i.e., a deterioration of the structure or a damage in the structure. Specifically, the abnormality diagnosis apparatus 1 is an apparatus that makes the structure vibrate by applying impact to the structure, and detects an abnormality in the structure using the vibration. Also, as illustrated in FIG. 1, the abnormality diagnosis apparatus 1 includes a feature amount calculation unit 2 and an abnormality detection unit 3.

Among these units, the feature amount calculation unit 2 is configured to perform, on mode vectors generated based on vibration of a structure measured by sensors, normalization of amplitude components and normalization for removing an initial phase from phase components, and calculate amplitude feature amounts corresponding to the amplitude components and phase feature amounts corresponding to the phase components. The abnormality detection unit 3 is configured to specify an abnormality in the structure based on the amplitude feature amounts and the phase feature amounts.

In such a manner, in the present example embodiment, normalization of amplitude components and phase components is performed on mode vectors generated based on vibration of the structure, and thus the influence of statistical variation of the mode vectors can be suppressed. Accordingly, an abnormality in the structure can be detected accurately.

For example, the structure is a hardened material (concrete, mortar, or the like) that is solidified using at least sand, water, and cement, a metal, or a structure constructed using such materials. Alternatively, the structure is an entirety or part of a building. Further alternatively, the structure is an entirety or part of a machine.

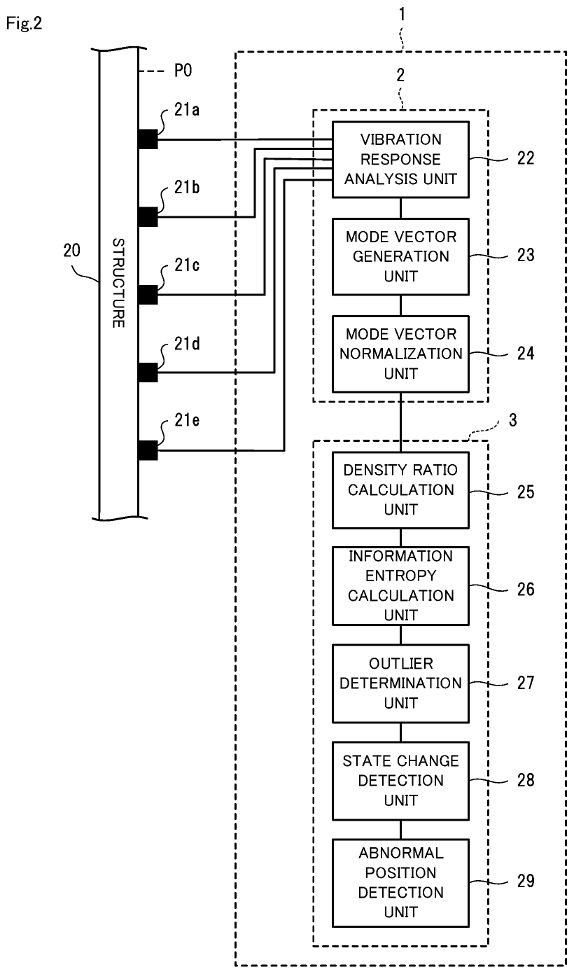

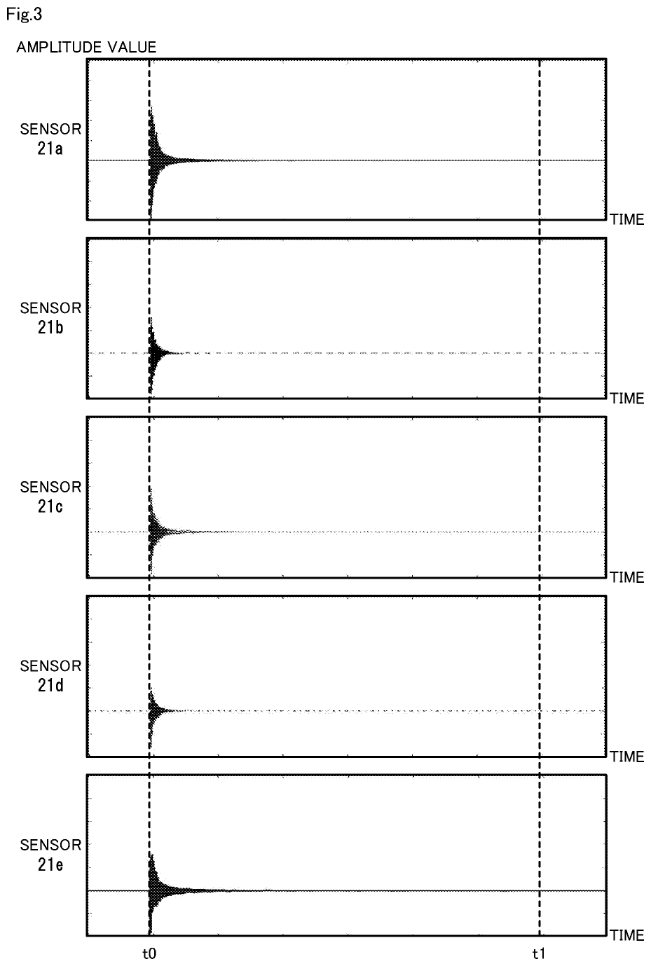

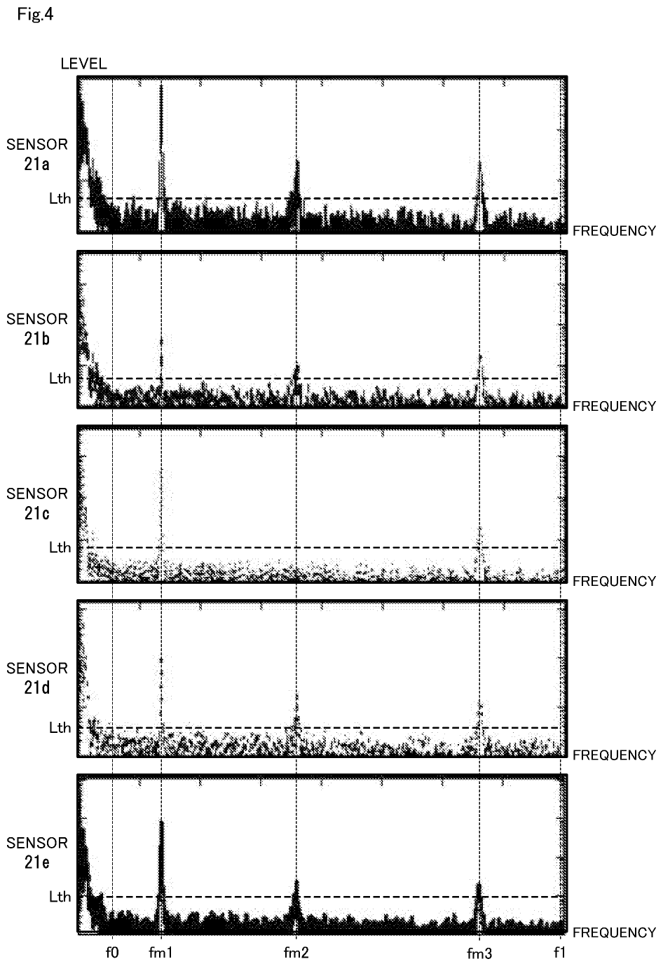

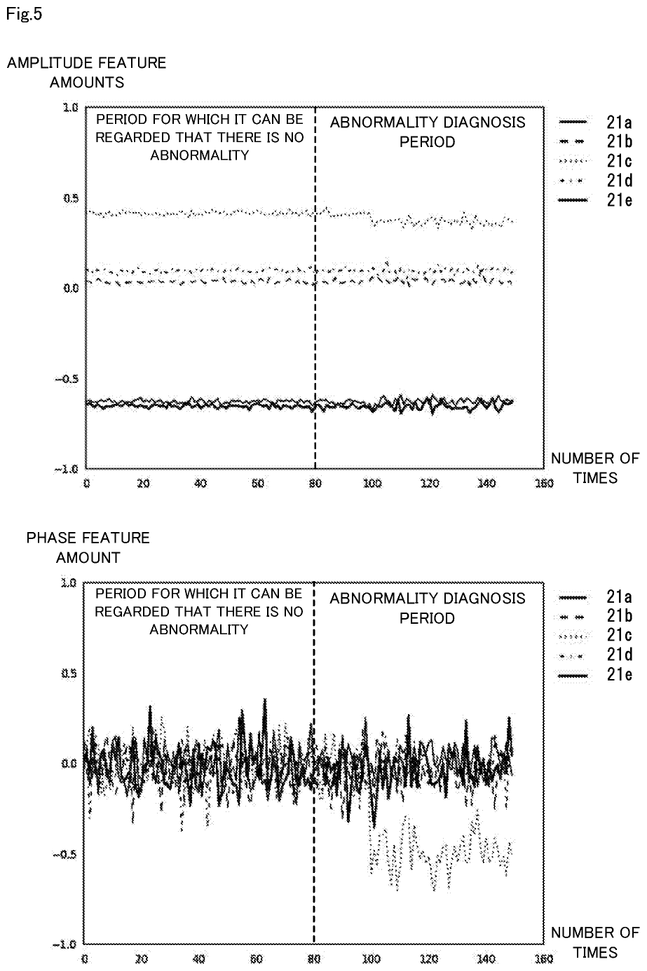

Next, the configuration of the abnormality diagnosis apparatus 1 in the present example embodiment will be specifically described with reference to FIGS. 2, 3, 4, and 5. FIG. 2 is a diagram specifically illustrating the abnormality diagnosis apparatus and a system including the abnormality diagnosis apparatus. FIG. 3 is a diagram illustrating one example of vibration waves of individual sensors. FIG. 4 is a diagram illustrating one example of Fourier-transformed vibration waves. FIG. 5 is a diagram illustrating relationships between the number of times impact is applied to a structure, and amplitude feature amounts and phase feature amounts.

As illustrated in FIG. 2, the abnormality diagnosis system in the present example embodiment includes the abnormality diagnosis apparatus 1 and a plurality of sensors 21 (in FIG. 2, the sensors 21 are shown as sensors 21a, 21b, 21c, 21d, and 21e).

The sensors 21 are attached to a structure 20, and measure at least the magnitude of vibration of the structure 20 and transmit information indicating the measured magnitude of vibration to the abnormality diagnosis apparatus 1. For example, the sensors 21 transmit, to the abnormality diagnosis apparatus 1, signals including information indicating the measured magnitude of vibration. For example, the use of triaxial acceleration sensors, etc., as the sensors 21 can be considered.

Specifically, as illustrated in FIG. 2, the plurality of sensors 21a to 21e attached to the structure 20 each measure acceleration at the position to which the sensor is attached. Next, the plurality of sensors 21a to 21e each transmit, to the abnormality diagnosis apparatus 1, a signal including information regarding the measured acceleration. Note that wired or wireless communication or the like is used for the communication between the sensors 21 and the abnormality diagnosis apparatus 1.

The feature amount calculation unit will be described.

The feature amount calculation unit 2 calculates mode vectors based on the information indicating the magnitude of the vibration of the structure 20 measured by the sensors 21. Next, the feature amount calculation unit 2 performs normalization on amplitude components of the calculated mode vectors, and calculates amplitude feature amounts corresponding to the amplitude components. Also, the feature amount calculation unit 2 performs normalization for removing an initial phase from phase components of the calculated mode vectors, and calculates phase feature amounts corresponding to the phase components. Note that the feature amount calculation unit 2 includes a vibration response analysis unit 22, a mode vector generation unit 23, and a mode vector normalization unit 24.

The vibration response analysis unit 22 acquires, from each of the plurality of sensors 21a to 21e, information (vibration wave) indicating vibration of the structure 20, as illustrated in FIG. 3. Next, the vibration response analysis unit 22 executes a Fourier transform on vibration waves acquired at a period of time set in advance. For example, the vibration response analysis unit 22 performs a discrete Fourier transform using sampling data of vibration waves acquired between time t0 and time t1, as illustrated in FIG. 3, and transforms vibration waves represented in the frequency-time domain so as to be represented in the frequency-level domain (a plurality of frequencies set in advance (unit frequencies) and levels corresponding to the frequencies), as illustrated in FIG. 4. For example, the levels are power spectral densities, etc.

Next, the vibration response analysis unit 22 analyzes the information obtained by Fourier-transforming the vibration waves, detects the frequency having the highest level within a predetermined frequency range (range from which low frequencies are excluded), and sets the detected frequency as a natural frequency. For example, as illustrated in FIG. 4, the vibration response analysis unit 22 detects, in the sensors 21ato 21e, frequencies corresponding to levels higher than or equal to a predetermined value Lth within the predetermined frequency range (from f0 to f1), and sets natural frequencies fm1, fm2, and fm3 (primary, secondary, and tertiary modes). For example, a different value may be adopted as the predetermined value Lth for each of the sensors 21a to 21e.

The mode vector generation unit 23 generates mode vectors for the detected natural frequencies. For example, for each of the natural frequencies fm1, fm2, and fm3, the mode vector generation unit 23 generates a mode vector using complex vectors as shown in Formula (1) for the sensors 21a to 21e.

$$\vert {φ}_{m} 〉 = ( \begin{matrix}{A}^{m} ( {x}_{1} ) {e}^{i {θ}^{m} ( {x }_{1} )} \\ {A}^{m} ( {x}_{2} ) {e}^{i {θ}^{m} ( {x }_{2} )} \\ {A}^{m} ( {x}_{3} ) {e}^{i {θ}^{m} ( {x }_{3} )} \\ {A}^{m} ( {x}_{4} ) {e}^{i {θ}^{m} ( {x }_{4} )} \\ {A}^{m} ( {x}_{5} ) {e}^{i {θ}^{m} ( {x }_{5} )}\end{matrix} ) \\ \vert {φ}_{m} 〉 \text{:} Mode vector using complex vectors m \text{:} Symbol for identifying plurality of modes included in vibration \\ {x}_{n} \text{:} Distance from starting point P 0 to each sensor ( where n is 1 to 5 ) \\ {A}^{m} ( {x}_{n} ) \text{:} Amplitude at natural frequency ( where n is 1 to 5 ) \\ {θ}^{m} ( {x}_{n} ) \text{:} Phase at natural frequency ( where n is 1 to 5 ) \qquad [ Formula 1 ]$$

The mode vector normalization unit 24 performs normalization on the amplitude components of the generated mode vectors, and calculates amplitude feature amounts corresponding to the amplitude components. Specifically, the mode vector normalization unit 24 calculates amplitude feature amounts for the complex vectors corresponding to the sensors 21a to 21e using Formula (2). For example, values obtained by dividing the amplitude components by a square root of sum of squares of the amplitude components (normalization parameter) are calculated and set as amplitude feature amounts.

$${Z}_{m} = \sqrt{〈 {φ}_{m} \vert {φ}_{m} 〉} = \sqrt{{\sum }_{n} {( {A}^{m} ( {x}_{n} ) )}^{2}} \\ {A}_{n}^{m} ← {A}^{m} ( {x}_{n} ) \text{/} {Z}_{m} \\ {Z}_{m} \text{:} Square root of sum of squares of amplitude components \qquad [ Formula 2 ]$$

In addition, the mode vector normalization unit 24 performs normalization (phase correction) of removing an initial phase from the phase components of the generated mode vectors, and calculates phase feature amounts corresponding to the phase components. Specifically, the mode vector normalization unit 24 calculates phase feature amounts for the complex vectors corresponding to the sensors 21a to 21e using Formula (3). For example, values obtained by subtracting the mode vector angle in the complex space (correction parameter) from the phase components are calculated and set as phase feature amounts.

$${ζ}_{m} = arctan ( \frac{\sum {( {A}_{n}^{m} )}^{2} sin {θ}^{m} ( {x}_{n} ) cos {θ}^{m} ( {x}_{n} )}{\sum {( {A}_{n}^{m} )}^{2} {cos}^{2} {θ}^{m} ( {x}_{n} )} ) \\ {θ}_{n}^{m} ← {θ}^{m} ( {x}_{n} ) - {ζ}_{m} \\ {ζ}_{m} \text{:} Mode vector angle in complex space \qquad [ Formula 3 ]$$

Note that the mode vector normalization unit 24 performs normalization for each of the natural frequencies fm1, fm2, and fm3.

The abnormality detection unit will be described.

The abnormality detection unit 3 detects a change in state of the structure 20 and an abnormal position in the structure 20. Also, the abnormality detection unit 3 includes: a density ratio calculation unit 25, an information entropy calculation unit 26, an outlier determination unit 27, a state change detection unit 28, and an abnormal position detection unit 29.

The abnormality detection unit 3 will be specifically described with reference to FIG. 5. The amplitude feature amounts and phase feature amounts shown in FIG. 5 are values calculated based on measurement values measured by the sensors 21a to 21e each time impact was applied to the structure 20 in a case in which impact was applied 160 times in the abnormality diagnosis. A period for which it can be regarded that there is no abnormality is a period for which the diagnosis has already been performed and a diagnosis has been made that there is no abnormality. An abnormality diagnosis period is a period for which a diagnosis as to whether there is an abnormality has not been made yet.

For each of the sensors 21, the density ratio calculation unit 25 calculates probability density ratios using feature amounts calculated during the abnormality diagnosis period of the structure 20 and reference feature amounts serving as references that have been calculated during the period for which it can be regarded that there is no abnormality in the structure 20.

Specifically, for each of the sensors 21a to 21e, the density ratio calculation unit 25 calculates amplitude probability density ratios between amplitude feature amounts calculated during the abnormality diagnosis period (80 to 160 times, inclusive) and reference amplitude feature amounts serving as references that have been calculated during the period for which it can be regarded that there is no abnormality (1 to 79 times, inclusive), as illustrated in FIG. 5. Alternatively, for each of the sensors 21ato 21e, the density ratio calculation unit 25 calculates phase probability density ratios between phase feature amounts calculated during the abnormality diagnosis period (80 to 160 times, inclusive) and reference phase feature amounts serving as references that have been calculated during the period for which it can be regarded that there is no abnormality (1 to 79 times, inclusive), as illustrated in FIG. 5. The amplitude probability density ratios and the phase probability density ratios are calculated based on Formula (4), for example.

$$r ( d ) = {\sum }_{i = 0}^{{N}_{n}} {α}_{i} {ψ}_{i} ( d ) \\ α = {( H + λ I )}^{- 1} h \\ H = \frac{1}{{N}_{q}} {\sum }_{n = 0}^{{N}_{q}} ψ ( {d}_{n}^{′} ) {ψ}^{t} ( {d}_{n}^{′} ) \\ h = \frac{1}{{N}_{p}} {\sum }_{n = 0}^{{N}_{p}} ψ ( {d}_{n} ) \\ r ( d ) \text{:} Probability density ratio d \text{:} Data from period for which it can be regarded that there is no abnormality \\ {d}^{′} \text{:} Data from abnormality diagnosis period α \text{:} Weighting coefficient {ψ}_{i} ( d ) \text{:} BRF kernel function \\ {N}_{n} \text{:} Number of bases ( number of data ) \\ {N}_{q} \text{:} Number of data during abnormality diagnosis period \\ {N}_{p} \text{:} Number of data during period for which it can be regarded that there is no abnormality \\ I \text{:} Unit matrix \qquad [ Formula 4 ]$$

For each of the sensors 21, the information entropy calculation unit 26 calculates information entropies (likelihood ratios) by multiplying the logarithm of the probability density ratios by a minus. The information entropies are calculated based on Formula (5), for example.

Score=−In(r(x)) [Formula 5]

Score: Information entropy

Specifically, for each of the sensors 21ato 21e, the information entropy calculation unit 26 calculates amplitude information entropies using the amplitude probability density ratios. Alternatively, for each of the sensors 21ato 21e, the information entropy calculation unit 26 calculates phase information entropies using the phase probability density ratios.

For each of the sensors 21, the outlier determination unit 27 determines that an information entropy is an outlier if the information entropy is greater than or equal to a predetermined value Rth set in advance. Also, for each of the sensors 21, the outlier determination unit 27 determines that an information entropy is a normal value if the information entropy is smaller than the predetermined value Rth. The predetermined value Rth is determined by creating an information entropy distribution and carrying out an experiment, a simulation, or the like based on the information entropy distribution.

Specifically, for each of the sensors 21ato 21e, the outlier determination unit 27 determines that an amplitude information entropy is an outlier if the information entropy is greater than or equal to an amplitude predetermined value Rtha set in advance. Alternatively, for each of the sensors 21a to 21e, the outlier determination unit 27 determines that a phase information entropy is an outlier if the information entropy is greater than or equal to a phase predetermined value Rthp set in advance. The amplitude predetermined value Rtha and the phase predetermined value Rthp are determined by an experiment, a simulation, or the like. Note that a One Class Support Vector Machine (OCSVM) may be applied to the outlier determination unit 27, and outliers may be determined using a trained model.

For each of the sensors 21, the state change detection unit 28 determines whether or not the frequency of occurrence of information entropies greater than or equal to the predetermined value Rth (information entropies that are outliers) is higher than or equal to a predetermined frequency.

Specifically, the state change detection unit 28 adds an addition value set in advance to a determination value if the outlier determination unit 27 determines as an outlier. Alternatively, the state change detection unit 28 subtracts a subtraction value set in advance from the determination value if the outlier determination unit 27 determines as a normal value. That is, the state change detection unit 28 calculates a cumulative sum using outliers and normal values.

For example, in a case in which the predetermined value Rth is set to a value corresponding to the lower 95% or the higher 5% in a frequency distribution of information entropies during the period for which it can be regarded that there is no abnormality, the addition value and the subtraction value are set to 0.95 and 0.05, respectively. Note that a configuration is adopted such that the expected value is 0 if the determination value (cumulative sum) is calculated.

Next, the state change detection unit 28 detects that a change in state of the structure 20 has occurred if the determination value is higher than or equal to a predetermined frequency Cth set in advance. That is, the state change detection unit 28 estimates that there is an abnormality in the structure 20. The predetermined frequency Cth is determined by an experiment, a simulation, or the like.

The abnormal position detection unit 29 detects sensors 21 for which the frequency of occurrence of information entropies greater than or equal to the predetermined value Rth (information entropies that are outliers) is higher than or equal to the predetermined frequency Cth. By detecting sensors 21 in such a manner, it can be estimated that there is an abnormality at the position of a sensor 21 installed on the structure 20 or that there is an abnormality near a sensor 21.

Specifically, the abnormal position detection unit 29 specifies sensors 21 for which the frequency of occurrence of amplitude information entropies greater than or equal to the amplitude predetermined value Rtha is higher than or equal to an amplitude predetermined frequency Ctha. Alternatively, the abnormal position detection unit 29 specifies sensors 21 for which the frequency of occurrence of phase information entropies greater than or equal to the predetermined value Rthp is higher than or equal to a phase predetermined frequency Cthp. The amplitude predetermined frequency Ctha and the phase predetermined frequency Cthp are determined by an experiment, simulation, or the like.

[Apparatus Operations]

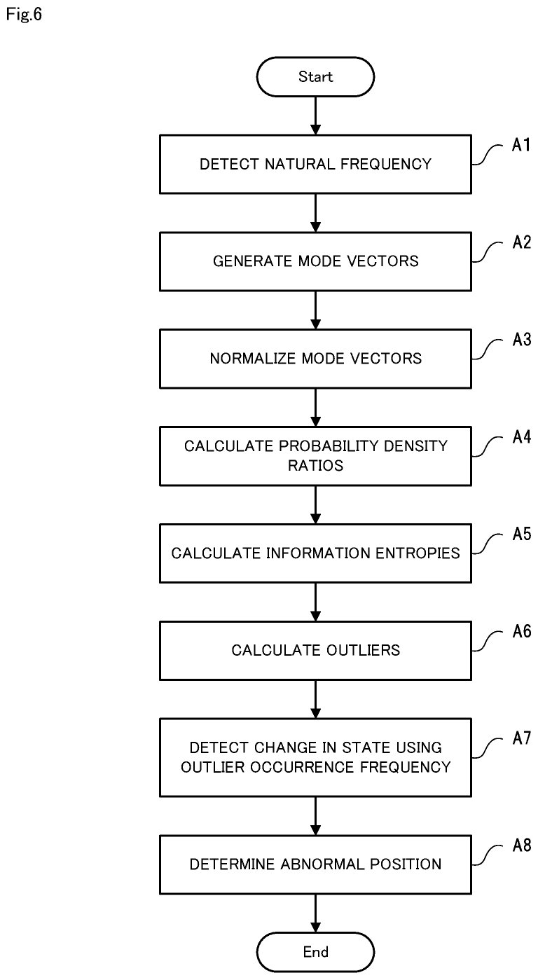

Next, operations of the abnormality diagnosis apparatus in the example embodiment of the invention will be described with reference to FIG. 6. FIG. 6 is a diagram illustrating one example of operations of the abnormality diagnosis apparatus. FIGS. 2 to 5 will be referred to as needed in the following description. Also, in the present example embodiment, an abnormality diagnosis method is implemented by causing the abnormality diagnosis apparatus to operate. Accordingly, the following description of the operations of the abnormality diagnosis apparatus is substituted for the description of the abnormality diagnosis method in the present example embodiment.

As illustrated in FIG. 6, the vibration response analysis unit 22 detects a natural vibration frequency based on vibration of the structure measured by the sensors 21 installed on the structure 20 (step A1). Next, the mode vector generation unit 23 generates mode vectors using the detected natural vibration frequency (step A2). Next, the mode vector normalization unit 24 performs, on the generated mode vectors, normalization of amplitude components and normalization for removing an initial phase from phase components, and calculates amplitude feature amounts corresponding to the amplitude components and phase feature amounts corresponding to the phase components (step A3).

Next, the density ratio calculation unit 25 calculates probability density ratios that are calculated using the feature amounts calculated during an abnormality diagnosis period of the structure 20 and reference feature amounts serving as references that have been calculated during a period for which it can be regarded that there is no abnormality in the structure 20 (step A4). Next, the information entropy calculation unit 26 calculates information entropies based on the probability density ratios (step A5).

Next, the outlier determination unit 27 determines whether or not an information entropy is greater than or equal to a predetermined value, and determines whether the information entropy is an outlier or a normal value (step A6). The state change detection unit 28 detects whether or not information entropies that are greater than or equal to the predetermined value are occurring frequently at a frequency higher than or equal to a predetermined frequency (step A7). Next, the abnormal position detection unit 29 specifies a sensor for which information entropies exceeding the predetermined value have occurred at a frequency higher than or equal to the predetermined frequency (step A8).

Next, steps A1 to A8 illustrated in FIG. 6 will be specifically described.

In a case in which abnormality diagnosis of the structure 20 is performed using the abnormality diagnosis apparatus 1, the structure 20 is made to vibrate by applying impact to the structure 20 according to a technique such as hammering diagnosis, and the vibration is measured using the plurality of sensors 21. Furthermore, the abnormality diagnosis apparatus 1 performs abnormality diagnosis of the structure 20 using a plurality of measurement results measured by the plurality of sensors 21 when impact is applied to the structure 20 a plurality of times.

In step A1, the vibration response analysis unit 22 acquires information indicating vibration of the structure 20 from the plurality of sensors 21, and executes a Fourier transform on vibration waves acquired at a period of time set in advance. Next, the vibration response analysis unit 22 analyzes the information obtained by Fourier-transforming the vibration waves, detects frequencies corresponding to levels higher than or equal to the predetermined value Lth within the predetermined frequency range, and sets the detected frequencies as natural frequencies. For example, refer to the natural frequencies fm1, fm2, and fm3 shown in FIG. 3.

In step A2, for the natural frequencies of the sensors 21, the mode vector generation unit 23 generates mode vectors for each natural frequency using complex vectors as shown in above-described Formula (1).

In step A3, the mode vector normalization unit 24 calculates amplitude feature amounts for the complex vectors corresponding to the sensors 21 using above-described Formula (2). Also, in step A3, the mode vector normalization unit 24 calculates phase feature amounts for the complex vectors corresponding to the sensors 21 using above-described Formula (3).

In step A4, for each of the sensors 21, the density ratio calculation unit 25 calculates amplitude probability density ratios between amplitude feature amounts calculated during the abnormality diagnosis period and reference amplitude feature amounts serving as references that have been calculated during the period for which it can be regarded that there is no abnormality. Also, in step A4, for each of the sensors 21, the density ratio calculation unit 25 calculates phase probability density ratios between phase feature amounts calculated during the abnormality diagnosis period and reference phase feature amounts serving as references that have been calculated during a period for which it can be regarded that there is no abnormality. The amplitude probability density ratios and the phase probability density ratios are calculated based on above-described Formula (4).

In step A5, for each of the sensors 21, the information entropy calculation unit 26 calculates amplitude information entropies for the amplitude probability density ratios using above-described Formula (5). Alternatively, in step A5, for each of the sensors 21, the information entropy calculation unit 26 calculates phase information entropies for the phase probability density ratios using above-described Formula (5).

In step A6, for each of the sensors 21, the outlier determination unit 27 determines that an amplitude information entropy is an outlier if the information entropy is greater than or equal to the amplitude predetermined value Rtha set in advance. Also, if an amplitude information entropy is smaller than the amplitude predetermined value Rtha set in advance, the outlier determination unit 27 determines that the information entropy is a normal value. Alternatively, in step A6, for each of the sensors 21, the outlier determination unit 27 determines that a phase information entropy is an outlier if the information entropy is greater than or equal to the phase predetermined value Rthp set in advance. Also, if a phase information entropy is smaller than the phase predetermined value Rthp set in advance, the outlier determination unit 27 determines that the information entropy is a normal value.

In step A7, the state change detection unit 28 adds the addition value set in advance to the determination value if the outlier determination unit 27 determines as an outlier. Alternatively, the state change detection unit 28 subtracts the subtraction value set in advance from the determination value if the outlier determination unit 27 determines as a normal value. That is, the state change detection unit 28 calculates a cumulative sum using outliers and normal values.

In step A8, the abnormal position detection unit 29 specifies sensors 21 for which the frequency of occurrence of amplitude information entropies greater than or equal to the amplitude predetermined value Rtha is higher than or equal to the amplitude predetermined frequency Ctha. Alternatively, the abnormal position detection unit 29 specifies sensors 21 for which the frequency of occurrence of phase information entropies greater than or equal to the predetermined value Rthp is higher than or equal to the phase predetermined frequency Cthp.

[Effects of Embodiment]

As described above, according to the present example embodiment, normalization of amplitude components and phase components is performed on mode vectors generated based on vibration of a structure, and thus the influence of statistical variation of mode vectors can be suppressed.

In addition, since the influence of statistical variation can be suppressed, statistical comparison can be performed between all measurement values acquired during a period in which it can be regarded that there is no abnormality and all measurement values acquired during an abnormality diagnosis period. That is, an abnormality in a structure can be detected with higher accuracy compared to a case such as that in conventional technology in which a representative measurement value for a period in which it can be regarded that there is no abnormality and a representative measurement value for an abnormality diagnosis period are compared.

In addition, by calculating probability density ratios after performing normalization, information entropies can be calculated for amplitude and phase. Accordingly, a period in which there is no abnormality in a structure and a period in which there is an abnormality in the structure can be clearly shown.

[Program]

It suffices for the program in the example embodiment of the invention to be a program that causes a computer to execute steps A1 to A8 illustrated in FIG. 6. By installing this program on a computer and executing the program, the abnormality diagnosis apparatus and the abnormality diagnosis method in the present example embodiment can be realized. In this case, the processor of the computer functions and performs processing as the feature amount calculation unit 2 (the vibration response analysis unit 22, the mode vector generation unit 23, and the mode vector normalization unit 24) and the abnormality detection unit 3 (the density ratio calculation unit 25, the information entropy calculation unit 26, the outlier determination unit 27, the state change detection unit 28, and the abnormal position detection unit 29).

Also, the program in the present example embodiment may be executed by a computer system formed from a plurality of computers. In this case, the computers may each function as one of the feature amount calculation unit 2 (the vibration response analysis unit 22, the mode vector generation unit 23, and the mode vector normalization unit 24) and the abnormality detection unit 3 (the density ratio calculation unit 25, the information entropy calculation unit 26, the outlier determination unit 27, the state change detection unit 28, and the abnormal position detection unit 29), for example.

[Physical Configuration]

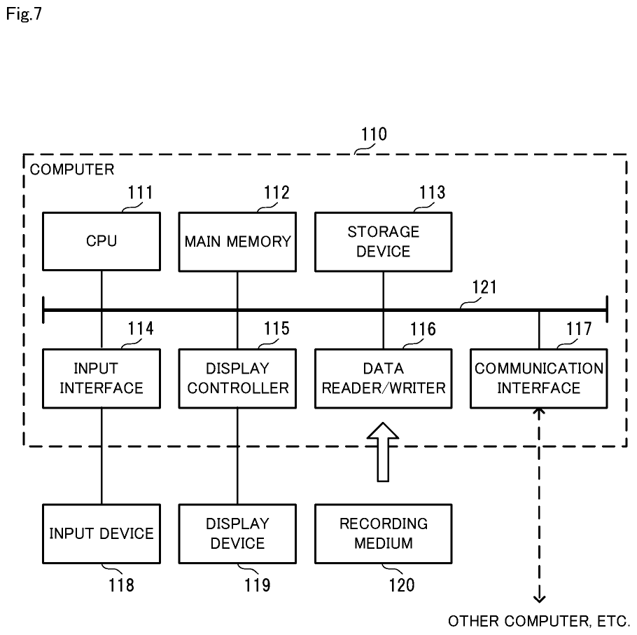

Here, a computer that realizes the abnormality diagnosis apparatus 1 by executing the program in the present example embodiment will be described with reference to FIG. 7. FIG. 7 is a diagram illustrating one example of a computer realizing the abnormality diagnosis apparatus in the example embodiment of the invention.

As illustrated in FIG. 7, a computer 110 includes a CPU 111, a main memory 112, a storage device 113, an input interface 114, a display controller 115, a data reader/writer 116, and a communication interface 117. These components are connected via a bus 121 so as to be capable of performing data communication with one another. Note that the computer 110 may include a graphics processing unit (GPU) or a field-programmable gate array (FPGA) in addition to the CPU 111 or in place of the CPU 111.

The CPU 111 loads the program (codes) in the present example embodiment, which is stored in the storage device 113, onto the main memory 112, and performs various computations by executing these codes in a predetermined order. The main memory 112 is typically a volatile storage device such as a dynamic random access memory (DRAM) or the like. Also, the program in the present example embodiment is provided in a state such that the program is stored in a computer readable recording medium 120. Note that the program in the present example embodiment may also be a program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119.

The data reader/writer 116 mediates data transmission between the CPU 111 and the recording medium 120, and executes the reading of the program from the recording medium 120 and the writing of results of processing in the computer 110 to the recording medium 120. The communication interface 117 mediates data transmission between the CPU 111 and other computers.

Also, specific examples of the recording medium 120 include a general-purpose semiconductor storage device such as a CompactFlash (registered trademark, CF) card or a Secure Digital (SD) card, a magnetic recording medium such as a flexible disk, and an optical recording medium such as a compact disk read-only memory (CD-ROM).

[Supplementary Note]

In relation to the above example embodiment, the following Supplementary Notes are further disclosed. While a part of or the entirety of the above-described example embodiment can be expressed by (Supplementary Note 1) to (Supplementary Note 15) described in the following, the invention is not limited to the following description.

(Supplementary Note 1)

An abnormality diagnosis apparatus including:

a feature amount calculation unit configured to perform, on mode vectors generated based on vibration of a structure measured by sensors, normalization of amplitude components and normalization for removing an initial phase from phase components, and calculate amplitude feature amounts corresponding to the amplitude components and phase feature amounts corresponding to the phase components; and

an abnormality detection unit configured to specify an abnormality in the structure based on the amplitude feature amounts and the phase feature amounts.

(Supplementary Note 2)

The abnormality diagnosis apparatus according to Supplementary Note 1, wherein

the abnormality detection unit calculates amplitude information entropies based on amplitude probability density ratios between the amplitude feature amounts calculated during an abnormality diagnosis period of the structure and reference amplitude feature amounts serving as references that have been calculated during a period for which it can be regarded that there is no abnormality in the structure.

(Supplementary Note 3)

The abnormality diagnosis apparatus according to Supplementary Note 2, wherein

the abnormality detection unit specifies the sensors for which the frequency of occurrence of amplitude information entropies greater than or equal to a predetermined value is higher than or equal to a predetermined frequency.

(Supplementary Note 4)

The abnormality diagnosis apparatus according to Supplementary Note 1, wherein

the abnormality detection unit calculates phase information entropies based on phase probability density ratios between the phase feature amounts calculated during an abnormality diagnosis period of the structure and reference phase feature amounts serving as references that have been calculated during a period for which it can be regarded that there is no abnormality in the structure.

(Supplementary Note 5)

The abnormality diagnosis apparatus according to Supplementary Note 4, wherein

the abnormality detection unit specifies the sensors for which the phase information entropies exceeding a predetermined value have occurred at a frequency higher than or equal to a predetermined frequency.

(Supplementary Note 6)

An abnormality diagnosis method including:

(A) a step of performing, on mode vectors generated based on vibration of a structure measured by sensors, normalization of amplitude components and normalization for removing an initial phase from phase components, and calculating amplitude feature amounts corresponding to the amplitude components and phase feature amounts corresponding to the phase components; and

(B) a step of specifying an abnormality in the structure based on the amplitude feature amounts and the phase feature amounts.

(Supplementary Note 7)

The abnormality diagnosis method according to Supplementary Note 6, wherein

in the step (B), amplitude information entropies are calculated based on amplitude probability density ratios between the amplitude feature amounts calculated during an abnormality diagnosis period of the structure and reference amplitude feature amounts serving as references that have been calculated during a period for which it can be regarded that there is no abnormality in the structure.

(Supplementary Note 8)

The abnormality diagnosis method according to Supplementary Note 7, wherein

in the step (B), the sensors for which the frequency of occurrence of amplitude information entropies greater than or equal to a predetermined value is higher than or equal to a predetermined frequency are specified.

(Supplementary Note 9)

The abnormality diagnosis method according to Supplementary Note 6, wherein

in the step (B), phase information entropies are calculated based on phase probability density ratios between the phase feature amounts calculated during an abnormality diagnosis period of the structure and reference phase feature amounts serving as references that have been calculated during a period for which it can be regarded that there is no abnormality in the structure.

(Supplementary Note 10)

The abnormality diagnosis method according to Supplementary Note 9, wherein

in the step (B), the sensors for which the phase information entropies exceeding a predetermined value have occurred at a frequency higher than or equal to a predetermined frequency are specified.

(Supplementary Note 11)

A computer readable recording medium that includes an abnormality diagnosis program recorded thereon, the abnormality diagnosis program including instructions causing a computer to execute:

(A) a step of performing, on mode vectors generated based on vibration of a structure measured by sensors, normalization of amplitude components and normalization for removing an initial phase from phase components, and calculating amplitude feature amounts corresponding to the amplitude components and phase feature amounts corresponding to the phase components; and

(B) a step of specifying an abnormality in the structure based on the amplitude feature amounts and the phase feature amounts.

(Supplementary Note 12)

The computer readable recording medium according to Supplementary Note 11, wherein the computer readable recording medium includes the abnormality diagnosis program recorded thereon, which

in the step (B), calculates amplitude information entropies based on amplitude probability density ratios between the amplitude feature amounts calculated during an abnormality diagnosis period of the structure and reference amplitude feature amounts serving as references that have been calculated during a period for which it can be regarded that there is no abnormality in the structure.

(Supplementary Note 13)

The computer readable recording medium according to Supplementary Note 12, wherein the computer readable recording medium includes the abnormality diagnosis program recorded thereon, which

in the step (B), specifies the sensors for which the frequency of occurrence of amplitude information entropies greater than or equal to a predetermined value is higher than or equal to a predetermined frequency.

(Supplementary Note 14)

The computer readable recording medium according to Supplementary Note 11, wherein the computer readable recording medium includes the abnormality diagnosis program recorded thereon, which

in the step (B), calculates phase information entropies based on phase probability density ratios between the phase feature amounts calculated during an abnormality diagnosis period of the structure and reference phase feature amounts serving as references that have been calculated during a period for which it can be regarded that there is no abnormality in the structure.

(Supplementary Note 15)

The computer readable recording medium according to Supplementary Note 14, wherein the computer readable recording medium includes the abnormality diagnosis program recorded thereon, which

in the step (B), specifies the sensors for which the phase information entropies exceeding a predetermined value have occurred at a frequency higher than or equal to a predetermined frequency.

The invention has been described with reference to an example embodiment above, but the invention is not limited to the above-described example embodiment. Within the scope of the invention, various changes that could be understood by a person skilled in the art could be applied to the configurations and details of the invention.

### INDUSTRIAL APPLICABILITY

According to the invention, an abnormality in a structure can be detected accurately. The present invention is useful in fields in which abnormality diagnosis of structures is necessary.

### REFERENCE SIGNS LIST

1 Abnormality diagnosis apparatus
2 Feature amount calculation unit
3 Abnormality detection unit
20 Structure
21, 21a, 21b, 21c, 21d Sensors
22 Vibration response analysis unit
23 Mode vector generation unit
24 Mode vector normalization unit
25 Density ratio calculation unit
26 Information entropy calculation unit
27 Outlier determination unit
28 State change detection unit
29 Abnormal position detection unit
110 Computer
111 CPU
112 Main memory
113 Storage device
114 Input interface
115 Display controller
116 Data reader/writer
117 Communication interface
118 Input equipment
119 Display device
120 Recording medium
121 Bus

What is claimed is:

1. An abnormality diagnosis apparatus comprising:
a feature amount calculation unit configured to perform, on mode vectors generated based on vibration of a structure measured by sensors, normalization of amplitude components and normalization for removing an initial phase from phase components, and calculate amplitude feature amounts corresponding to the amplitude components and phase feature amounts corresponding to the phase components; and
an abnormality detection unit configured to specify an abnormality in the structure based on the amplitude feature amounts and the phase feature amounts.

2. The abnormality diagnosis apparatus according to claim 1, wherein
the abnormality detection unit calculates amplitude information entropies based on amplitude probability density ratios between the amplitude feature amounts calculated during an abnormality diagnosis period of the structure and reference amplitude feature amounts serving as references that have been calculated during a period for which it can be regarded that there is no abnormality in the structure.

3. The abnormality diagnosis apparatus according to claim 2, wherein
the abnormality detection unit specifies the sensors for which the frequency of occurrence of amplitude information entropies greater than or equal to a predetermined value is higher than or equal to a predetermined frequency.

4. The abnormality diagnosis apparatus according to claim 1, wherein
the abnormality detection unit calculates phase information entropies based on phase probability density ratios between the phase feature amounts calculated during an abnormality diagnosis period of the structure and reference phase feature amounts serving as references that have been calculated during a period for which it can be regarded that there is no abnormality in the structure.

5. The abnormality diagnosis apparatus according to claim 4, wherein
the abnormality detection unit specifies the sensors for which the phase information entropies exceeding a predetermined value have occurred at a frequency higher than or equal to a predetermined frequency.

6. An abnormality diagnosis method comprising:
performing, on mode vectors generated based on vibration of a structure measured by sensors, normalization of amplitude components and normalization for removing an initial phase from phase components, and calculating amplitude feature amounts corresponding to the amplitude components and phase feature amounts corresponding to the phase components; and
specifying an abnormality in the structure based on the amplitude feature amounts and the phase feature amounts.

7. The abnormality diagnosis method according to claim 6, wherein
amplitude information entropies are calculated based on amplitude probability density ratios between the amplitude feature amounts calculated during an abnormality diagnosis period of the structure and reference amplitude feature amounts serving as references that have been calculated during a period for which it can be regarded that there is no abnormality in the structure.

8. The abnormality diagnosis method according to claim 7, wherein
the sensors for which the frequency of occurrence of amplitude information entropies greater than or equal to a predetermined value is higher than or equal to a predetermined frequency are specified.

9. The abnormality diagnosis method according to claim 6, wherein
phase information entropies are calculated based on phase probability density ratios between the phase feature amounts calculated during an abnormality diagnosis period of the structure and reference phase feature amounts serving as references that have been calculated during a period for which it can be regarded that there is no abnormality in the structure.

10. The abnormality diagnosis method according to claim 9, wherein
the sensors for which the phase information entropies exceeding a predetermined value have occurred at a frequency higher than or equal to a predetermined frequency are specified.

11. A non-transitory computer readable recording medium that includes an abnormality diagnosis program recorded thereon, the abnormality diagnosis program including instructions causing a computer to execute:
performing, on mode vectors generated based on vibration of a structure measured by sensors, normalization of amplitude components and normalization for removing an initial phase from phase components, and calculating amplitude feature amounts corresponding to the amplitude components and phase feature amounts corresponding to the phase components; and
specifying an abnormality in the structure based on the amplitude feature amounts and the phase feature amounts.

12. The non-transitory computer-readable recording medium according to claim 11, wherein the computer readable recording medium includes the abnormality diagnosis program recorded thereon, which
calculates amplitude information entropies based on amplitude probability density ratios between the amplitude feature amounts calculated during an abnormality diagnosis period of the structure and reference amplitude feature amounts serving as references that have been calculated during a period for which it can be regarded that there is no abnormality in the structure.

13. The non-transitory computer-readable recording medium according to claim 12, wherein the computer readable recording medium includes the abnormality diagnosis program recorded thereon, which
specifies the sensors for which the frequency of occurrence of amplitude information entropies greater than or equal to a predetermined value is higher than or equal to a predetermined frequency.

14. The non-transitory computer-readable recording medium according to claim 11, wherein the computer readable recording medium includes the abnormality diagnosis program recorded thereon, which
calculates phase information entropies based on phase probability density ratios between the phase feature amounts calculated during an abnormality diagnosis period of the structure and reference phase feature amounts serving as references that have been calculated during a period for which it can be regarded that there is no abnormality in the structure.

15. The non-transitory computer-readable recording medium according to claim 14, wherein the computer readable recording medium includes the abnormality diagnosis program recorded thereon, which
specifies the sensors for which the phase information entropies exceeding a predetermined value have occurred at a frequency higher than or equal to a predetermined frequency.
